(19) United States
(12) Patent Application Publication
(10) Pub. No.: US 2008/0266711 A1
(43) Pub. Date: Oct. 30, 2008

(54) TAPE HEAD HAVING A PROTECTIVE LAYER AND A METHOD OF APPLYING A PROTECTIVE LAYER TO A TAPE HEAD

(75) Inventors: John P. Nibarger, Superior, CO (US); Kevin D. McKinstry, Denver, CO (US)

Correspondence Address: BROOKS KUSHMAN P.C. / SUN / STK, 1000 TOWN CENTER, TWENTY-SECOND FLOOR, SOUTHFIELD, MI, 48075-1238, US

(73) Assignee: SUN MICROSYSTEMS, INC., Santa Clara, CA (US)

(21) Appl. No.: 11/740,991

(22) Filed: Apr. 27, 2007

(51) Int. Cl. G11B 15/60; G11B 5/127

(52) U.S. Cl. 360/130.21; 977/943

(57) ABSTRACT

A tape head for use with a magnetic tape includes a support structure that has a tape bearing surface that is configured to engage the magnetic tape as the magnetic tape passes over the support structure. The support structure is made of a first material having a first hardness. The tape head further includes a transducer element having an interface surface for reading from and/or writing to the magnetic tape as the magnetic tape passes over the tape bearing surface. The tape head also includes a protective layer that substantially covers the interface surface, the protective layer being made of a second material having a second hardness that is at least as hard as the first hardness of the first material.

### BACKGROUND OF THE INVENTION

1. Field of the Invention

A tape head for use with a data storage tape drive system and a method of applying a protective coating to a tape head for use with a data storage tape drive system.

2. Discussion

Data storage tape drive systems are commonly used in the computer, audio, and video fields to record and store large volumes of information for subsequent retrieval and use. A data storage tape drive system generally includes a data storage tape cartridge and a tape drive mechanism selectively engaged with the data storage tape cartridge. The tape drive mechanism frequently includes a tape head having transducers for interacting with, recording data to, or reading data from, the storage tape. The transducer is used for reading longitudinally extending data tracks of a magnetic tape and generating respective read data signals in response to reading the data tracks. The transducer moves laterally with respect to the data tracks to read a desired data track as the magnetic tape moves across the tape head.

The tape head may also be comprised of a support structure, including a substrate and a closure. The support structure may include a tape bearing surface to support the magnetic tape as it travels over the tape head. The support structure may also support one or more transducers which enable the magnetic read/write head to read from, and to write to the magnetic tape as it passes over the tape bearing surface of the support structure. The transducer may be disposed within the substrate such that a surface of the transducer is substantially flush with the tape bearing surface. In this configuration, the flush surface of the transducer (the “interactive surface”) may interact with the magnetic tape allowing the transducer to read from and to write to the magnetic tape as the tape passes over the tape bearing surface.

One problem sometimes encountered with the tape head assembly described above is that the magnetic tape may abrade both the support structure and the transducer as it passes over them, causing erosion. Because the support structure may be comprised of a material that is harder and more resistant to erosion then the transducer, the transducer may tend to erode more quickly than the support structure. This leads to an increase in the distance between the interactive surface and the magnetic tape as it engages the tape head. This condition can degrade the tape head's ability to read from and to write to the magnetic tape. This and other problems are addressed by the present invention.

### SUMMARY OF THE INVENTION

A tape head for use with a magnetic tape and a method of making a tape head having a protective layer is provided herein. In at least a first embodiment, the tape head comprises a support structure having a tape bearing surface that is configured to engage the magnetic tape as the magnetic tape passes over the support structure. The support structure comprises a first material having a first hardness. A transducer element is also provided having an interface surface for reading from and/or writing to the magnetic tape as the magnetic tape passes over the tape bearing surface. A protective layer substantially covers the interface surface. The protective layer comprises a second material having a hardness that is at least as hard as the first hardness of the first material.

In at least one implementation of the first embodiment, the second material has a second hardness that is harder than the first hardness of the first material.

In at least another implementation of the first embodiment, the transducer element is disposed within the support structure.

In at least another implementation of the first embodiment, the interface surface is disposed below the tape bearing surface. In at least one variation of this implementation, the interface surface is disposed between approximately 5 nm to 50 nm below the tape bearing surface.

In at least another implementation of the first embodiment, the protective layer is between approximately 5 nm and 30 nm in thickness.

In at least another implementation of the first embodiment, the first material comprises AlTiC.

In at least another implementation of the first embodiment, the second material comprises a diamond like carbon. In at least one variation of this implementation, the second material further comprises silicon.

In at least another implementation of the first embodiment, the first material comprises AlTiC and the second material comprises silicon and diamond like carbon.

In at least another implementation of the first embodiment, the protective layer substantially covers the tape bearing surface.

In at least a second embodiment, the tape head comprises a support structure assembly having a tape bearing surface that is configured to engage the magnetic tape as the magnetic tape passes over the support structure assembly. The support structure assembly comprises a plurality of joined support members, each support member having a support member tape support surface. The plurality of support members are aligned along their respective support member tape support surfaces to form the tape bearing surface. Each support member comprises a first material having a first hardness. The tape head further comprises a plurality of transducer elements, each transducer element having an interface surface for reading from and/or writing to the magnetic tape as the magnetic tape passes over the support structure assembly. The tape head further comprises a protective layer substantially covering each interface surface. The protective layer comprises a second material having a second hardness greater than the first hardness of the first material.

In at least one implementation of the second embodiment, the first material comprises AlTiC.

In at least another implementation of the second embodiment, the second material comprises a diamond like carbon.

In at least one variation of this implementation, the second material further comprises silicon. Additionally, the interface surface may be recessed below the tape bearing surface.

In at least a third embodiment, a method of making a tape head having a protective layer is provided. The method may include the steps of providing a tape head having a support structure that includes a tape bearing surface and a transducer element, the support structure comprising a first material having a first hardness, the transducer element having an interface surface disposed proximate the tape bearing surface, and applying a protective surface to the support structure, the protective surface substantially covering the tape bearing surface and the interface surface, the protective coating comprising a second material having a second hardness that is at least as hard as the first hardness of the first material.

In at least one implementation of the third embodiment, the method further comprises the step of lapping the tape bearing surface and the interface surface with a finishing tape to induce recession of the interface surface below the tape bearing surface prior to performing the step of applying the protective coating to the support structure.

In at least another implementation of the third embodiment, the step of applying a protective surface to the support structure comprises the steps of placing a carbon material at least partially into a vacuum chamber, placing the tape head at least partially into the vacuum chamber such that the tape bearing surface is disposed proximate the carbon material, and inducing a plasma proximate the carbon material to sputter a diamond like carbon layer onto the tape bearing surface and the interface surface. In at least one variation of this implementation comprises the further step of lapping the tape bearing surface with a finishing tape to remove the diamond like carbon layer from the tape bearing surface.

### BRIEF DESCRIPTION OF THE DRAWINGS

FIG. 1 is a simplified side view of a tape head engaging a magnetic tape;

FIG. 2 is a simplified fragmentary side view of the portion of the tape head circled in FIG. 1;

FIG. 3 illustrates the portion of the tape head shown in FIG. 2 after recession of the transducer element below the tape bearing surface;

FIG. 4 illustrates the tape head of FIG. 3 after a protective layer has been deposited on the tape bearing surface and the transducer element;

FIG. 5 illustrates the tape head of FIG. 4 after the protective coating has been removed from the tape bearing surface of the substrate; and

FIG. 6 is a flow chart illustrating an embodiment of the method of the present invention.

### DETAILED DESCRIPTION OF THE PREFERRED EMBODIMENT(S)

Reference will now be made in detail to the illustrated embodiments of the present invention which include the best modes of practicing the invention presently known to the inventors. The following descriptions are merely exemplary in nature and in no way intended to limit the invention, its application, or uses. The Figures are not necessarily drawn to scale. Specific details disclosed herein are not to be interpreted as limiting, but merely as a representative basis for any aspect of the invention and/or as a representative basis for teaching one skilled in the art to variously employ the present invention.

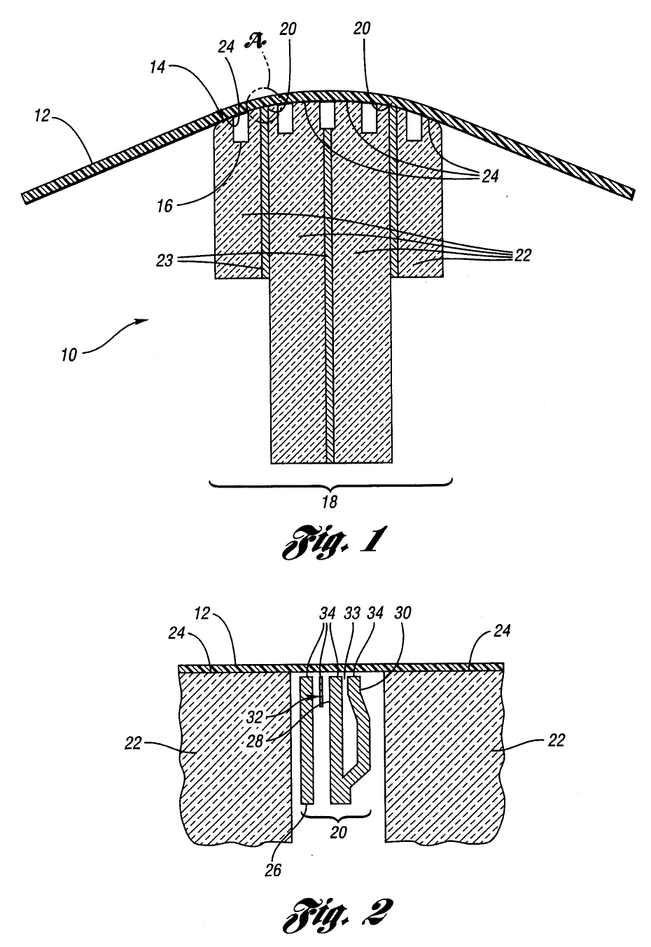

FIG. 1 is a simplified side view of a tape head 10 engaging a magnetic tape 12. Tape head 10 is connected to a data storage tape drive system (not shown). Magnetic tape 12 may contain data that has been recorded in a magnetic form that is readable by tape head 10. Magnetic tape 12 passes across and engages a tape bearing surface 14 of tape head 10. As magnetic tape 12 engages the tape bearing surface 14, tape head 10 may read data from and/or write data to magnetic tape 12.

In the illustrated embodiment, tape bearing surface 14 has a partial cylindrical curvature to ensure sufficient engagement between the magnetic tape 12 and the tape bearing surface 14. In other embodiments, the tape bearing surface 14 may be flat or may have any other desirable configuration to ensure engagement between the tape bearing surface 14 and the magnetic tape 12. To further facilitate engagement between tape bearing surface 14 and magnetic tape 12, a plurality of air tracks 16 have been milled into the tape bearing surface 14. Air tracks 16 serve as a pathway to direct trapped air away from the space between magnetic tape 12 and tape bearing surface 14.

Tape head 10 further comprises a support structure 18 and two transducer elements 20. The transducer elements 20 contain the components which read from and which write to the magnetic tape 12 as it engages the tape bearing surface 14. Transducer element 20 may be at least partially embedded or otherwise disposed within support structure 18. In the illustrated embodiment, the support structure 18 is comprised of a plurality of discrete support members 22. In the illustrated embodiment, support structure 18 is comprised of four adjoined support members 22. In other embodiments, a greater or lesser number of support members 22 may be utilized. Each support member 22 has a support member tape support surface 24. The support members 22 are adjoined to one another such that their respective substrate member tape support surfaces 24 align and form a contiguous surface (the tape bearing surface 14). The support members 22 are adjoined to one another using an adhesive 23. In the illustrated embodiment, transducer elements 20 are disposed between two adjoining support members 22 and proximate to the tape bearing surface 14.

FIG. 2 is an expanded view of the portion of the tape head 10 of FIG. 1 that is circled by a phantom line and designated with the reference letter A. The portion illustrated in FIG. 2 includes portions of two adjacent support members 22 and a transducer element 20 disposed therebetween. Transducer element 20 includes a bottom shield 26, a shared shield 28, a top pole 30 and a read sensor 32. The bottom shield 26 and the shared shield 28 magnetically shield the read sensor 32, allowing the read sensor 32 to focus on a discrete, isolated portion of magnetic tape 12 as it passes over transducer element 20. This magnetic isolation facilitates the read sensor's 32 ability to read from the magnetic tape 12. A gap 33 between the shared shield 28 and the top pole 30 provides a structure for writing to the magnetic tape 12. The area between bottom shield 26 and read sensor 32 is filled with alumina, also known as aluminum oxide. Alumina is a thermal and electrical insulator that further enhances the ability of the bottom shield 26 and shared shield 28 to magnetically insulate read sensor 32. Bottom shield 26, shared shield 28 and top pole 30 are preferably made from a material comprising cobalt, zirconium, and tantalum or a material comprising nickel and iron. The read sensor 32 may be made from a variety of metals including copper. Support members 22 are preferably made from a material comprising aluminum titanium carbide (AlTiC).

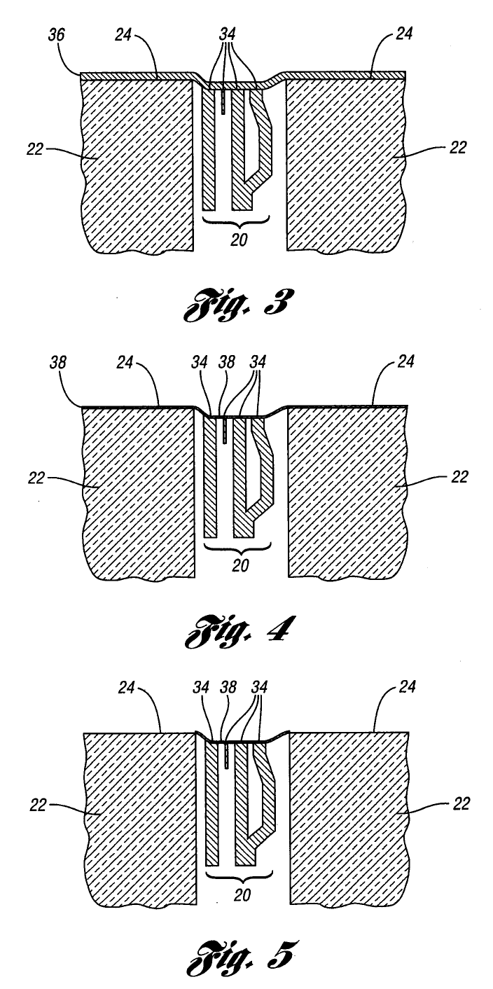

As the magnetic tape 12 travels across the support member tape support surface 24, it passes over interface surface 34 (the surface of the transducer element 20 that is proximate to and engages with magnetic tape 12 for reading from and writing to the magnetic tape 12). Because the materials comprising the transducer element 20 may be softer than the materials comprising support members 22, transducer element 20 may erode more quickly than the support members 22. This erosion, also known as pole tip recession, is illustrated in FIG. 3 where the interface surface 34 is shown recessed below the support member tape support surfaces 24. Continued use of the tape head 10 may result in further erosion of the transducer element 20 leading to a degraded read/write performance of tape head 10 due to the increased distance between the magnetic tape and the interface surface 34. After a time, a steady state condition develops in which the pole tip recession does not increase further.

In at least one embodiment of the present invention, the recession of the interface surface 34 is deliberately induced. As shown in FIG. 3, a diamond lapping tape 36 is used to shape the contour of the tape bearing surface 14 (see FIG. 1) and also to induce recession of interface surface 34. Preferably, interface surface 34 will be recessed between 5 and 50 nm below the support member tape support surface 24 and most preferably will be recessed between 20 to 30 nm below the support member tape support surface 34. Once the desired recession of interface surface 34 is obtained, a diamond like carbon layer 38 is applied to the tape bearing surface 14 including the interface surfaces 34, as illustrated in FIG. 4. The diamond like carbon layer 38 may be applied using a sputtering technique (discussed below). Preferably, the diamond like carbon layer 38 may be between 5 and 30 nm in thickness, and is more preferably between 5 and 10 nm in thickness. The diamond like carbon material may be harder than the material comprising the transducer element 20 and may also be harder than the material comprising support members 22. The diamond like carbon layer 38 shields both the support member tape support surface 24 and the interface surface 34 from the abrasive effect of the magnetic tape 12 and thus may inhibit further recession of interface surface 34.

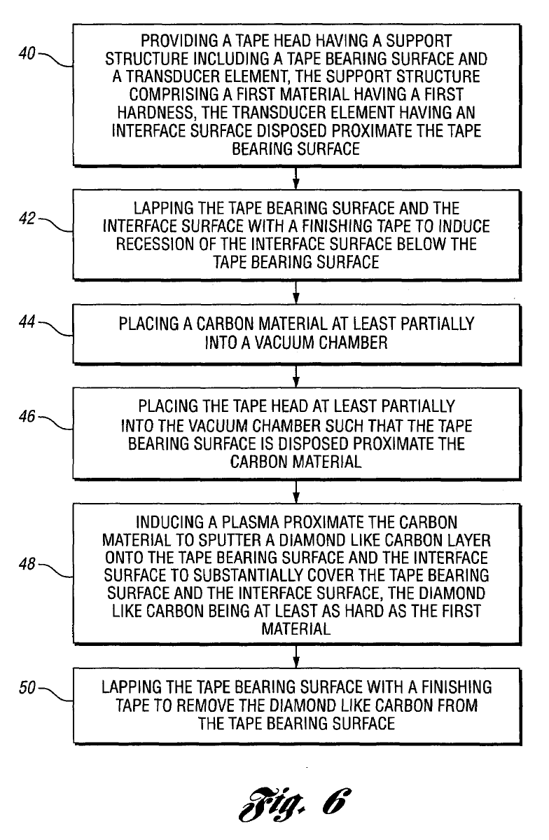

In a preferred embodiment (illustrated in FIG. 5), the diamond like carbon coating 38 may be removed from the support member tape support surfaces 24 such that only the interface surface 34 remains covered. This permits the magnetic tape 12 to pass as close as possible to the interface surface 34 to facilitate good read/write performance from tape head 10.

In at least another embodiment, the invention includes a method of applying a protective layer to tape head 10. An embodiment of this method is illustrated in the flow chart of FIG. 6 at steps 40 through 48. This method may include providing a tape head having support structure 18 and transducer element 20. The tape head 10 may comprise a first material having a first hardness and may include a tape bearing surface 14 to engage a magnetic tape 12. The transducer element 20 may include an interface surface 34 for reading from and writing to the magnetic tape 12 as it passes over the tape bearing surface 14, the interface surface 34 being disposed proximate to the tape bearing surface 14. In at least one embodiment, the method may include the step of lapping the tape bearing surface 14 and the interface surface 34 with a finishing tape to induce recession of the interface surface 34 below the tape bearing surface 14. Preferably, the interface surface 34 may be recessed between 5 to 50 nm below the tape bearing surface 14 and more preferably may be recessed between 5 to 10 nm below the tape bearing surface 14. The finishing tape induces the recession of the interface surface 34 because the finishing tape may have particulates that are harder than the material comprising the transducer elements 20 but which are not as hard as the material comprising the support structure 18. This relative hardness causes the interactive surface 34 to recede below the tape bearing surface 14 as the finishing tape laps over the tape bearing surface 14. This step may also remove scratches from the tape bearing surface 14.

Next, a protective layer 38 is applied to the support structure 18. The protective layer may substantially cover the tape bearing surface 14 and the interface surface 34. The protective layer 38 comprises a second material having a second hardness that is at least as hard as the first hardness of the first material.

While any method of applying the protective layer 38 to the support structure 18 may be utilized, in at least one embodiment, the protective surface 38 may be applied to the support structure 18 by sputtering a diamond like carbon material onto support structure 18. This may be accomplished by placing a carbon material at least partially into a vacuum chamber. An example of a carbon material which may be used for this purpose is graphite. The tape head 10 may also be placed at least partially into the vacuum chamber. The tape head 10 is preferably oriented such that the tape bearing surface 14 is disposed proximate to the carbon material.

With both the carbon material and the tape head 10 disposed at least partially within the vacuum chamber, a plasma may be induced proximate to the carbon material. This may cause the carbon material to eject carbon atoms which may then fall onto or otherwise attach themselves to the tape bearing surface 14 of the support structure 18 and the interface surface 34 of the transducer element 20. Preferably, the carbon atoms will be ejected at a relatively slow rate, for example, one angstrom per minute. By depositing the carbon atoms at this rate, the carbon atoms are permitted to build up a layer in an organized manner, forming a diamond like configuration having triangularly shaped bonds. This diamond like carbon layer 38, which may be at least as hard as the hardness of the first material, and may be harder, may substantially cover the tape bearing surface 14 and the interface surface 34.

Once the diamond like carbon layer 38 is substantially covering the tape bearing surface 14 and the interface surface 34, the process for making a tape head having a protective layer may be complete. Alternatively, it may be desirable to remove the diamond like carbon layer 38 from the tape bearing surface 14, leaving the diamond like carbon layer 38 in place over only the interactive surface 34. To do this, an additional step of lapping the tape bearing surface 14 with the finishing tape may be undertaken. Because the diamond like carbon layer 38 over the interface surface 34 may be recessed below the tape bearing surface 14, the lapping tape is less likely to remove the diamond like carbon layer 38 from the interface surface.

To facilitate attachment of the diamond like carbon material to the tape bearing surface 14 and to the interface surface 34, a silicon material may be used to act as a bonding agent between the tape bearing surface 14, the interface surface 34 and the diamond like carbon layer 38. This may be accomplished by sputtering a layer of silicon onto the tape bearing surface 14 and the interface surface 34 in the same manner as the carbon material, but prior to the sputtering of the diamond like carbon layer 38 onto the tape bearing surface 14 and the interface surface 34.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A tape head for use with a magnetic tape, the tape head comprising:
a support structure having a tape bearing surface configured to engage the magnetic tape as the magnetic tape passes over the support structure, the support structure comprising a first material having a first hardness;
a transducer element having an interface surface for reading from and/or writing to the magnetic tape as the magnetic tape passes over the tape bearing surface; and
a protective layer substantially covering the interface surface, the protective layer comprising a second material having a second hardness that is at least as hard as the first hardness of the first material.

2. The tape head of claim 1 wherein the second material has a second hardness that is harder than the first hardness of the first material.

3. The tape head of claim 1 wherein the transducer element is disposed within the support structure.

4. The tape head of claim 1 wherein the interface surface is disposed below the tape bearing surface.

5. The tape head of claim 4 wherein the interface surface is disposed between approximately 5 nm to 50 nm below the tape bearing surface.

6. The tape head of claim 1 wherein the protective layer is between approximately 5 nm and 30 nm in thickness.

7. The tape head of claim 1 wherein the first material comprises AlTiC.

8. The tape head of claim 1 wherein the second material comprises a diamond like carbon.

9. The tape head of claim 8 wherein the second material further comprises silicon.

10. The tape head of claim 1 wherein the first material comprises AlTiC and the second material comprises silicon and diamond like carbon.

11. The tape head of claim 1 wherein the protective layer substantially covers the tape bearing surface.

12. A tape head for use with a magnetic tape, the tape head comprising:
a support structure assembly having a tape bearing surface configured to engage the magnetic tape as the magnetic tape passes over the support structure assembly, the support structure assembly comprising a plurality of attached support members, each support member having a support member tape support surface, the plurality of support members being aligned along their respective support member tape support surfaces to form the tape bearing surface, each support member comprising a first material having a first hardness;
a plurality of transducer elements, each transducer element having an interface surface for reading from and/or writing to the magnetic tape as the magnetic tape passes over the support structure assembly; and
a protective layer substantially covering each interface surface, the protective layer comprising a second material having a second hardness greater than the first hardness of the first material.

13. The tape head of claim 12 wherein the first material comprises AlTiC.

14. The tape head of claim 12 wherein the second material comprises a diamond like carbon.

15. The tape head of claim 14 wherein the second material further comprises silicon.

16. The tape head of claim 15 wherein the interface surface is recessed below the tape bearing surface.

17. A method of making a tape head having a protective layer comprising the steps of:
providing a tape head having a support structure including a tape bearing surface and a transducer element, the support structure comprising a first material having a first hardness, the transducer element having an interface surface disposed proximate the tape bearing surface; and
applying a protective surface to the support structure, the protective surface substantially covering the tape bearing surface and the interface surface, the protective coating comprising a second material having a second hardness that is at least as hard as the first hardness of the first material.

18. The method of claim 17 comprising the further step of lapping the tape bearing surface and the interface surface with a finishing tape to induce recession of the interface surface below the tape bearing surface prior to performing the step of applying the protective coating to the support structure.

19. The method of claim 17 wherein the step of applying a protective surface to the support structure comprises the steps of:
placing a carbon material at least partially into a vacuum chamber;
placing the tape head at least partially into the vacuum chamber such that the tape bearing surface is disposed proximate the carbon material; and
inducing a plasma proximate the carbon material to sputter a diamond like carbon layer onto the tape bearing surface and the interface surface.

20. The method of claim 19 comprising the further step of lapping the tape bearing surface with a finishing tape to remove the diamond like carbon layer from the tape bearing surface.
